(19) United States
(12) Patent Application Publication
(10) Pub. No.: US 2005/0120832 A1
(43) Pub. Date: Jun. 9, 2005

(54) Ratchet wrench

(76) Inventor: Shui Lai Chiang, Taichung (TW)

Correspondence Address: Shui Lai Chiang, P.O. Box 63-298, Taichung, 406, TW

(21) Appl. No.: 10/730,211

(22) Filed: Dec. 5, 2003

(51) Int. Cl. B25B 13/00

(52) U.S. Cl. 81/59.1

(57) ABSTRACT

A ratchet wrench includes a head having a chamber to rotatably receive a follower, and a peripheral bulge extended into the chamber, to form an annular channel between the follower and the head. The follower includes six sides each having a recess to form six pairs of curved actuating surfaces, a cap is rotatably secured to the head and includes three or more actuator fingers to form three spaces between the actuator fingers and to receive rollers. The curved actuating surfaces of the follower are arranged to allow the rollers to be solidly engaged between the follower and the peripheral bulge of head.

### BACKGROUND OF THE INVENTION

1. Field of the Invention

The present invention relates to a ratchet wrench, and more particularly to a ratchet wrench having a solid driving mechanism for driving tools or fasteners.

2. Description of the Prior Art

Various kinds of typical ratchet wrenches have been developed and comprise a driving shank rotatably received in a head of a driving tool, and a ratchet mechanism or device disposed between the driving shank and the head of the driving tool, for allowing the driving shank to be rotated or driven in either a counterclockwise direction or a clockwise direction relative to the head of the driving tool.

For example, as shown in FIGS. 1-3, illustrated is a typical ratchet wrench comprising a handle 10, a head 11 formed or provided on one end of the handle 10 and including a chamber 12 formed therein for rotatably receiving a follower 40 therein, and including a peripheral bulge 14 extended radially into the chamber 12 of the head 11.

A ring or a washer 20 is secured to the lower portion of the head 11 with such as a retaining ring 15 which may be engaged into an inner peripheral recess 13 of the head 11, such that the washer 20 may enclose the lower portion of the chamber 12 of the head 11. The washer 20 includes a bore 21 formed therein. The washer 20 may be engaged with the peripheral bulge 14 of the head 11, and may thus be solidly secured to the head 11.

The follower 40 includes a driving shank 41 extended therefrom and rotatably received in the bore 21 of the washer 20 and having a peripheral groove 42 formed therein for receiving another retaining ring 23 which may be engaged with the washer 20, to rotatably secure the follower 40 to the head 11 with the washer 20. As shown in FIGS. 3 and 4, the follower 40 includes an outer diameter smaller than the inner diameter of the chamber 12 of the head 11, such that an annular channel 17 may be formed between the follower 40 and the head 11.

The follower 40 includes three or more, such as six recesses 43 formed in six sides 44 thereof, to form six pairs of flat actuating surfaces 45 thereon, best shown in FIGS. 3 and 4. The flat actuating surfaces 45 of flat follower 40 has an included angle “θ” with the inner peripheral surface of the head 11 (FIG. 4). The follower 40 further includes three pairs of depressions 46, 47 formed in the upper portion thereof and arranged corresponding to the pairs of flat actuating surfaces 45 thereof.

A cap 30 rotatably received in the chamber 12 of the head 11, and engaged with the peripheral bulge 14 of the head 11, to position the cap 30 relative to the head 11, and to prevent the cap 30 from being disengaged from the head 11. The cap 30 includes an aperture 31 formed therein to rotatably receive a shaft 48 that is extended from the follower 40, and that includes a peripheral groove 49 formed therein to receive another retaining ring 32 which may engage with the cap 30, to rotatably secure the cap 30 to the follower 40.

The cap 30 includes three or more, such as six actuator fingers 33 extended therefrom, to form three or more, such as six spaces 34 between the actuator fingers 33, and to receive form three or more, such as six rollers 50 within the spaces 34 of the cap 30. The rollers 50 may be caused to engage with either of the flat actuating surfaces 45 of the follower 40 by rotating the cap 30 relative to the head 11. The actuator fingers 33 and the rollers 50 are received in the annular channel 17 formed between the follower 40 and the head 11.

The cap 30 further includes three cavities 35 formed therein to receive three springs 60 and three balls or projections 70 that may be biased by the springs 60 to engage into either of the depressions 46, 47 of the follower 40, and to position the follower 40 relative to the head 11, and to maintain the rollers 50 in engagement with the respective flat actuating surfaces 45 of the follower 40.

However, as shown in FIG. 4, due to the flat actuating surfaces 45 of the follower 40, the rollers 50 may not be suitably or solidly engaged between the respective flat actuating surfaces 45 of the follower 40 and the inner peripheral surface of the head 11. Particularly, when the follower 40 is slowly rotated relative to the head 11, the rollers 50 may slip relative to the flat actuating surfaces 45 of the follower 40, such that the follower may not be solidly driven or rotated by the head 11.

The present invention has arisen to mitigate and/or obviate the afore-described disadvantages of the conventional ratchet wrenches.

### SUMMARY OF THE INVENTION

The primary objective of the present invention is to provide a ratchet wrench including a solid driving mechanism for solidly driving tools or fasteners.

In accordance with one aspect of the invention, there is provided a ratchet wrench comprising a head provided on a handle and including a chamber formed therein, and including a peripheral bulge extended radially into the chamber of the head, a follower rotatably received in the chamber of the head, and including an outer diameter smaller than an inner diameter of the chamber of the head, to form an annular channel between the follower and the head, the follower including six sides each having a recess formed therein, to form six pairs of curved actuating surfaces thereon, a cap rotatably received in the chamber of the head, and engaged with the peripheral bulge of the head, to position the cap relative to the head, the cap including at least three actuator fingers extended therefrom, to form at least three spaces between the actuator fingers, at least three rollers received within the spaces of the cap, the actuator fingers of the cap and the rollers being received in the annular channel formed between the follower and the head, the rollers being caused to be engaged between the curved actuating surfaces of the follower and the peripheral bulge of the head by rotating the cap relative to the head, and means for positioning the cap relative to the follower, to maintain engagements of the rollers with the respective curved actuating surfaces of the follower respectively. The curved actuating surfaces of the follower are arranged to allow the rollers to be solidly engaged between the curved actuating surfaces of the follower and the peripheral bulge of the head.

The head includes a washer secured thereto with a retaining ring and engaged with the peripheral bulge of the head, the washer includes a bore formed therein, the follower includes a driving shank extended therefrom and rotatably received in the bore of the washer and rotatably secured to the washer with a second retaining ring.

The cap includes an aperture formed therein, the follower includes a shaft extended therefrom, and rotatably engaged through the aperture of the cap, and rotatably secured to the cap with a retaining ring.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a typical ratchet wrench;

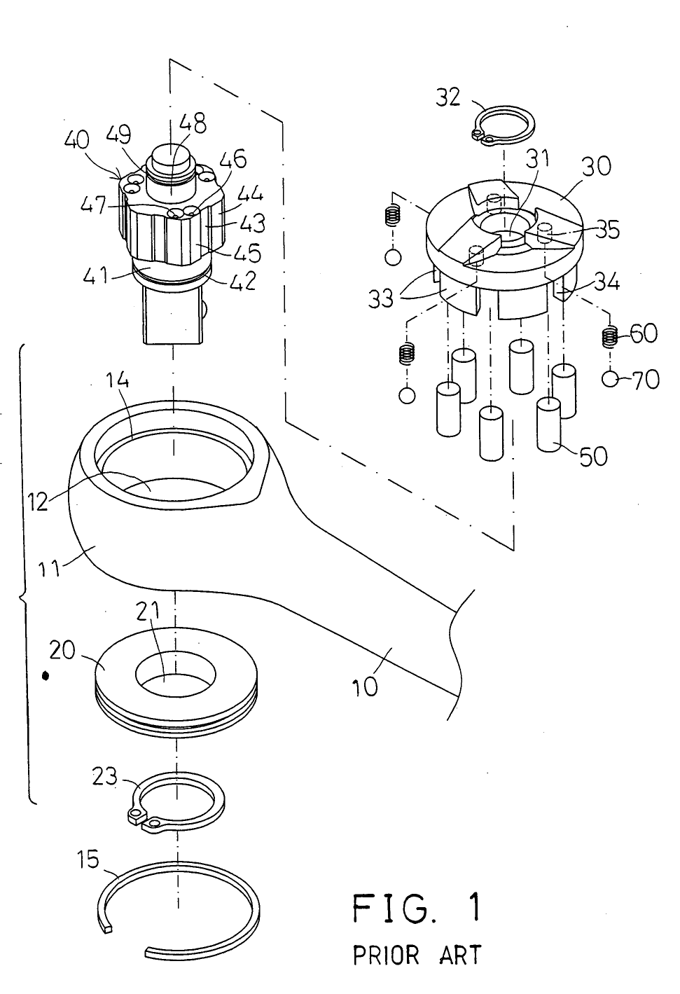

FIG. 2 is a partial cross sectional view of the typical ratchet wrench;

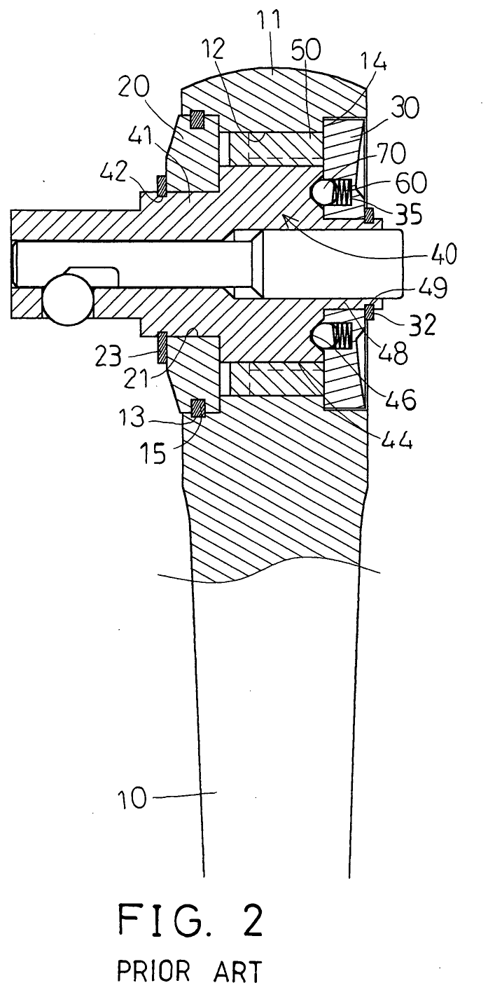

FIG. 3 is a partial top plan and partial cross sectional view of the typical ratchet wrench, in which a portion of the wrench has been cut off to show an inner structure of the typical ratchet wrench;

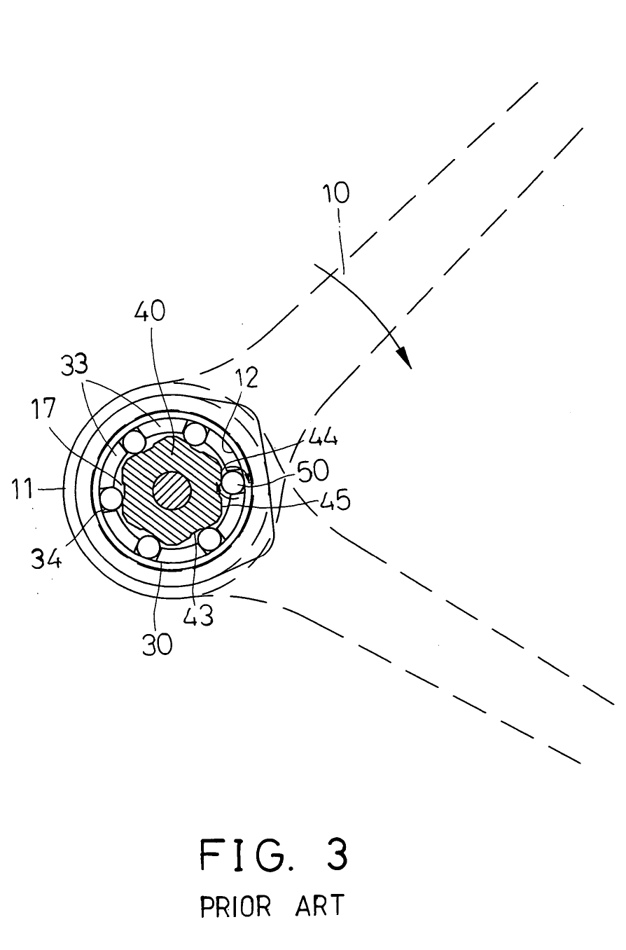

FIG. 4 is an enlarged partial top plan and partial cross sectional view of the typical ratchet wrench;

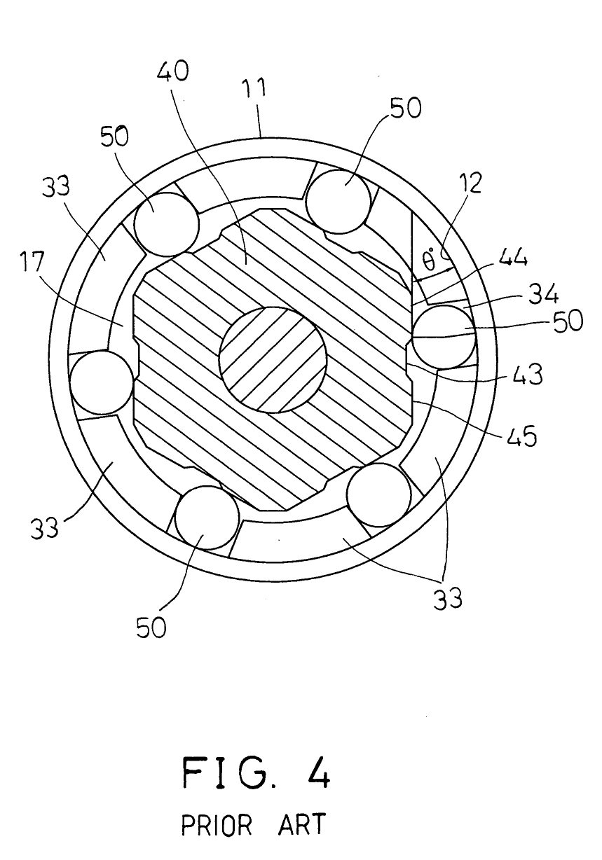

FIG. 5 is a perspective view of a ratchet wrench in accordance with the present invention;

FIG. 6 is an exploded view of the ratchet wrench;

FIG. 7 is a partial cross sectional view taken along lines 7-7 of FIG. 5;

FIG. 8 is a partial top plan and partial cross sectional view of the ratchet wrench, in which a portion of the wrench has been cut off to show an inner structure of the ratchet wrench; and

FIG. 9 is an enlarged partial top plan and partial cross sectional view of the ratchet wrench, illustrating the operation of the ratchet wrench.

### DETAILED DESCRIPTION OF THE PREFERRED EMBODIMENT

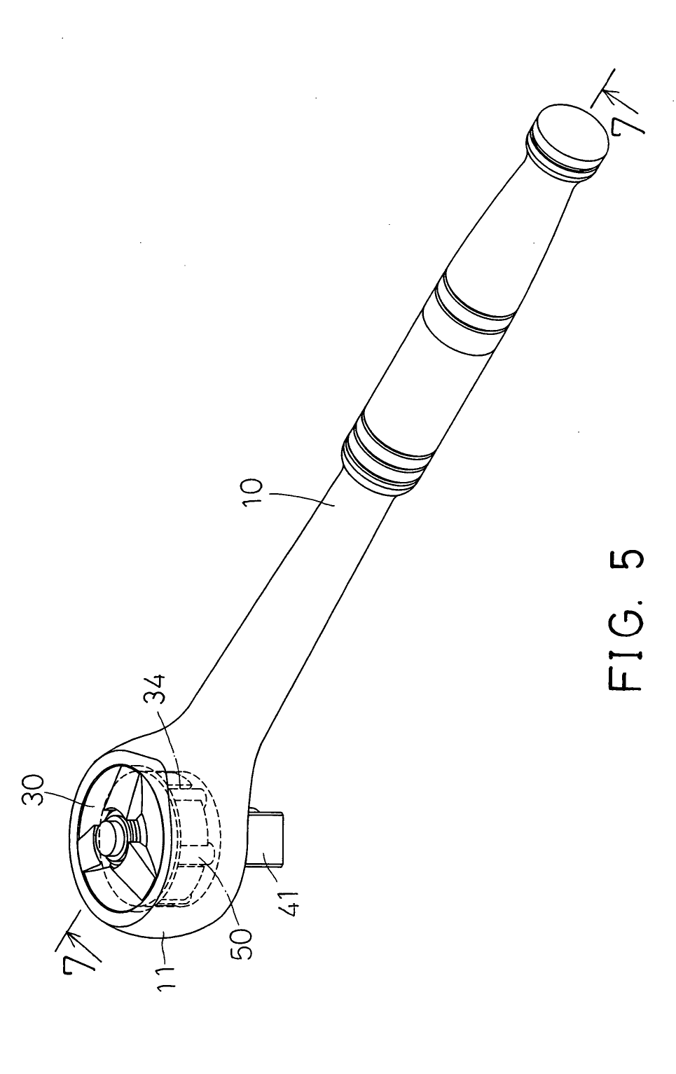

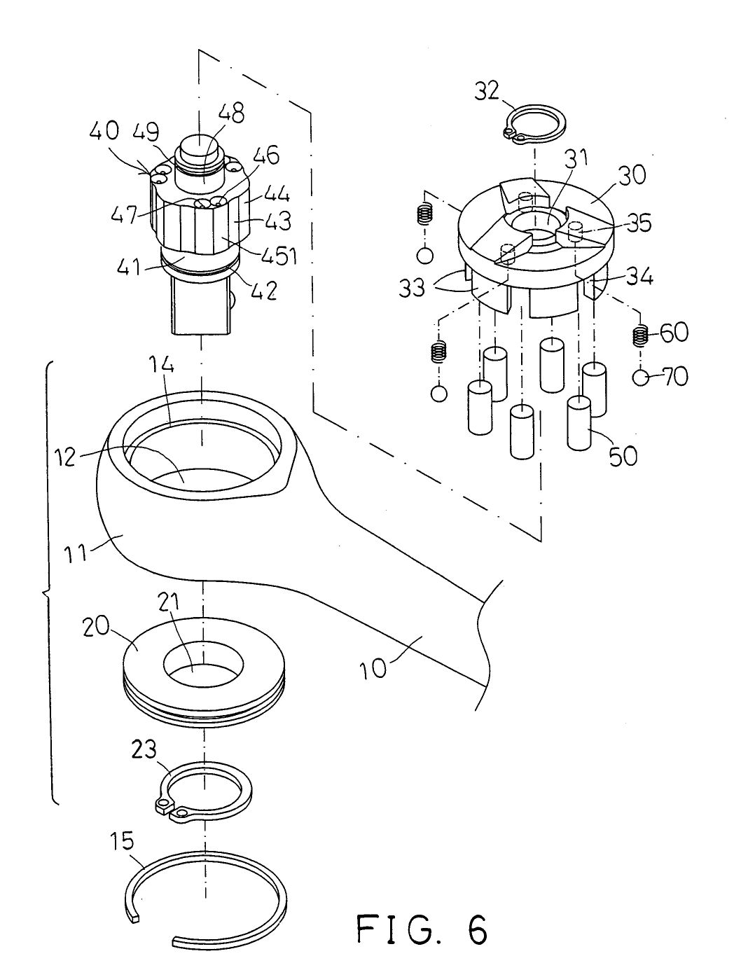

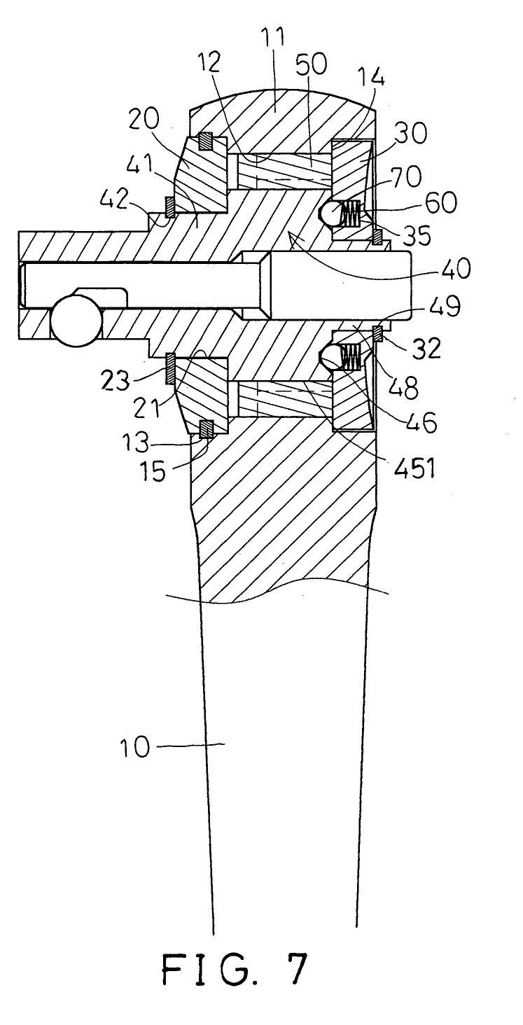

Referring to the drawings, and initially to FIGS. 5-8, a ratchet wrench in accordance with the present invention also comprises a handle 10, a head 11 formed or provided on one end of the handle 10 and including a chamber 12 formed therein for rotatably receiving a follower 40 therein, and including a peripheral bulge 14 extended radially into the chamber 12 of the head 11.

A ring or a washer 20 is secured to the lower portion of the head 11 with such as a retaining ring 15 which may be engaged into an inner peripheral recess 13 of the head 11, such that the washer 20 may enclose the lower portion of the chamber 12 of the head 11. The washer 20 includes a bore 21 formed therein. The washer 20 may be engaged with the peripheral bulge 14 of the head 11, and may thus be solidly secured to the head 11.

The follower 40 includes a driving shank 41 extended therefrom and rotatably received in the bore 21 of the washer 20 and having a peripheral groove 42 formed therein for receiving another retaining ring 23 which may be engaged with the washer 20, to rotatably secure the follower 40 to the head 11 with the washer 20. The driving shank 41 of the follower 40 may be used to rotate or drive various tools or fasteners.

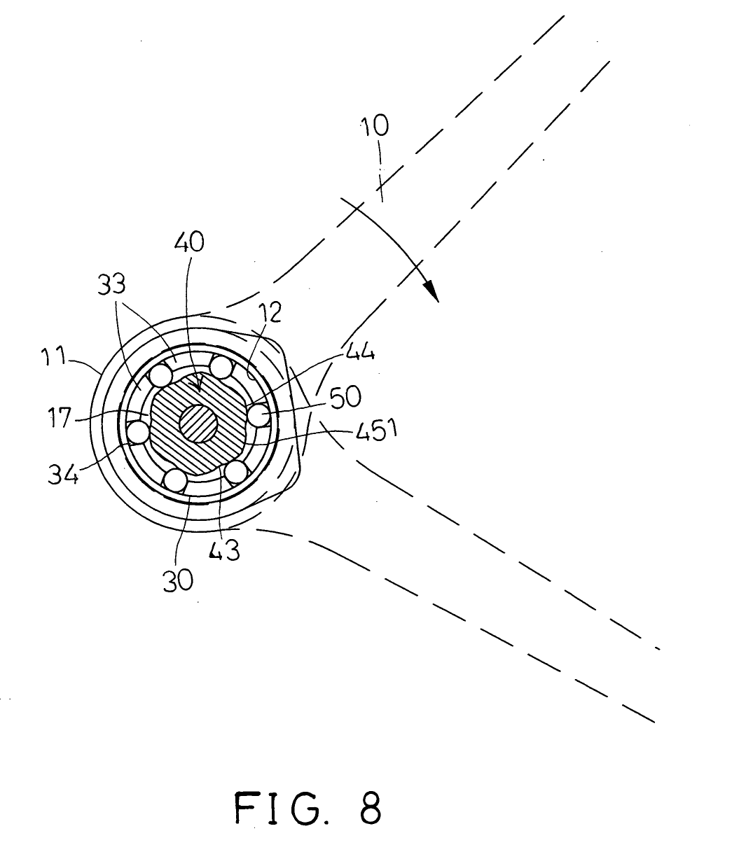

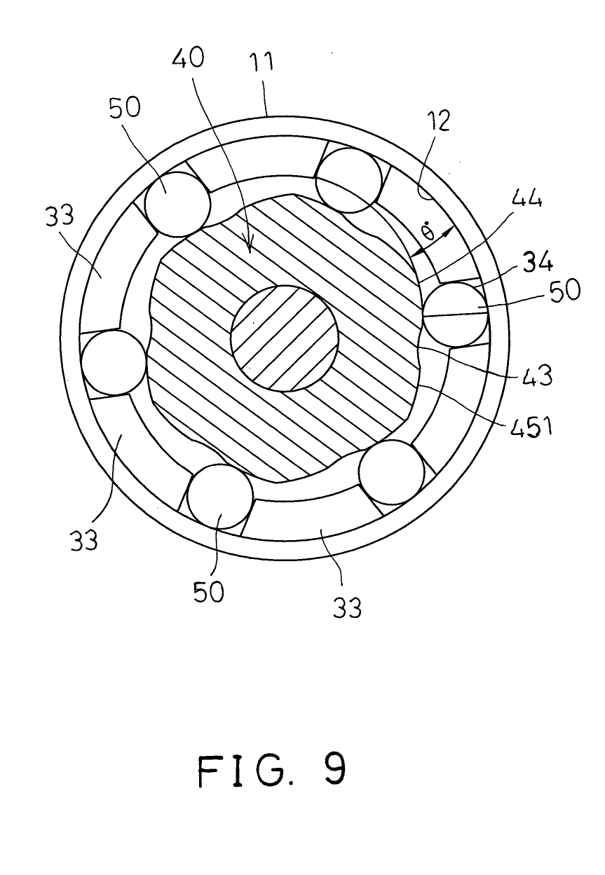

As shown in FIGS. 8 and 9, the follower 40 includes an outer diameter smaller than the inner diameter of the chamber 12 of the head 11, such that an annular channel 17 may be formed between the follower 40 and the head 11. The follower 40 includes three or more, such as six recesses 43 formed in six sides 44 thereof, and includes three pairs of depressions 46, 47 formed in the upper portion thereof and arranged corresponding to the six sides 44 thereof.

A cap 30 rotatably received in the chamber 12 of the head 11, and engaged with the peripheral bulge 14 of the head 11, to position the cap 30 relative to the head 11, and to prevent the cap 30 from being disengaged from the head 11. The cap 30 includes an aperture 31 formed therein to rotatably receive a shaft 48 that is extended from the follower 40, and that includes a peripheral groove 49 formed therein to receive another retaining ring 32 which may engage with the cap 30, to rotatably secure the cap 30 to the follower 40.

The cap 30 includes three or more, such as six actuator fingers 33 extended therefrom, to form three or more, such as six spaces 34 between the actuator fingers 33, and to receive form three or more, such as six rollers 50 within the spaces 34 of the cap 30. The actuator fingers 33 and the rollers 50 are received in the annular channel 17 formed between the follower 40 and the head 11.

The cap 30 further includes three cavities 35 formed therein to receive three springs 60 and three balls or projections 70 that may be biased by the springs 60 to engage into either of the depressions 46, 47 of the follower 40, and to position the follower 40 relative to the head 11. The above-identified structure is typical and thus will not be described in further details.

As shown in FIGS. 8 and 9, the follower 40 includes the six recesses 43 formed in six sides 44 thereof, to form six pairs of curved actuating surfaces 451 thereon. The six pairs of curved actuating surfaces 451 of the follower 40 are curved toward the inner peripheral surface or the peripheral bulge 14 of the head 11, and thus has a reduced or smaller included angle “θ” with the peripheral bulge 14 of the head 11, as compared with the flat actuating surfaces of the typical ratchet wrenches.

In operation, as best shown in FIGS. 8 and 9, the rollers 50 may be caused to engage with either of the curved actuating surfaces 451 of the follower 40 by rotating the cap 30 relative to the head 11, and may be solidly engaged between the curved actuating surfaces 451 of the follower 40 and the peripheral bulge 14 of the head 11, to allow the follower 40 to be solidly or effectively driven by the head 11, even when the handle 10 is rotated slowly or when the head 11 is rotated slowly relative to the follower 40.

Accordingly, the ratchet wrench in accordance with the present invention includes a solid driving mechanism for solidly driving tools or fasteners.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A ratchet wrench comprising:
a head provided on a handle and including a chamber formed therein, and including a peripheral bulge extended radially into said chamber of said head,
a follower rotatably received in said chamber of said head, and including an outer diameter smaller than an inner diameter of said chamber of said head, to form an annular channel between said follower and said head, said follower including six sides each having a recess formed therein, to form six pairs of curved actuating surfaces thereon,
a cap rotatably received in said chamber of said head, and engaged with said peripheral bulge of said head, to position said cap relative to said head, said cap including at least three actuator fingers extended therefrom, to form at least three spaces between said actuator fingers,
at least three rollers received within said at least three spaces of said cap, said actuator fingers of said cap and said at least three rollers being received in said annular channel formed between said follower and said head, said at least three rollers being caused to be engaged between said curved actuating surfaces of said follower and said peripheral bulge of said head by rotating said cap relative to said head, and
means for positioning said cap relative to said follower, to maintain engagements of said at least three rollers with said respective curved actuating surfaces of said follower respectively,
said curved actuating surfaces of said follower being arranged to allow said at least three rollers to be solidly engaged between said curved actuating surfaces of said follower and said peripheral bulge of said head.

2. The ratchet wrench as claimed in claim 1, wherein said head includes a washer secured thereto with a retaining ring and engaged with said peripheral bulge of said head, said washer includes a bore formed therein, said follower includes a driving shank extended therefrom and rotatably received in said bore of said washer and rotatably secured to said washer with a second retaining ring.

3. The ratchet wrench as claimed in claim 1, wherein said cap includes an aperture formed therein, said follower includes a shaft extended therefrom, and rotatably engaged through said aperture of said cap, and rotatably secured to said cap with a retaining ring.
